(19) United States
(12) Patent Application Publication
(10) Pub. No.: US 2008/0132091 A1
(43) Pub. Date: Jun. 5, 2008

(54) MEMORY CARD WITH IMPROVED COMMUNICATION SPEED AND MEMORY CARD SYSTEM INCLUDING THE SAME

(76) Inventor: Sung-Up Choi, Hwaseong-si (KR)

Correspondence Address: F. CHAU & ASSOCIATES, LLC, 130 WOODBURY ROAD, WOODBURY, NY, 11797, US

(21) Appl. No.: 11/692,369

(22) Filed: Mar. 28, 2007

(30) Foreign Application Priority Data
Dec. 4, 2006 (KR) 10-2006-121659

(51) Int. Cl. H01R 12/00

(52) U.S. Cl. 439/55

(57) ABSTRACT

A memory card includes first group pins, second group pins arranged apart from the first group pins, and a memory controller communicating externally through the first group pins in a legacy mode and communicating externally through the first and second group pins in a fast mode. The memory card including the second group pins, as well as the first group pins, is able to communicate with a host at a high frequency.

### CROSS-REFERENCE TO RELATED APPLICATION

This patent application claims priority under 35 U.S.C. § 119 of Korean Patent Application No. 2006-121659 filed on Dec. 4, 2006, the entire contents of which are hereby incorporated by reference.

### BACKGROUND

The present disclosure relates to memory cards.

With advancement of semiconductor device technology, semiconductor memory devices are being scaled down. Those almost microscopic semiconductor devices are widely provided as portable storage media and are accompanied by various interface types. For example, there are now several kinds of portable storage media, such as Compact Flash, Smart Media, Memory Stick, Secure Digital (SD) card, Multimedia card, and so forth.

Such various portable semiconductor memory devices are widely employed as large capacity storage media in portable electronic apparatuses, such as digital cameras, digital camcorders, mobile phones, and so on, with their own interface modes. More specifically, the multimedia card is a kind of flash memory card used as a storage device in a portable apparatus, such as a mobile phone, a personal digital assistant (PDA), a digital camera, or MP3, and is of great interest to world-wide mobile manufacturers owing to its merits of high performance, low power, miniaturization, and meeting public standards.

On the other hand, KIOSK is an unmanned information terminal installed in a public area, such as a governmental or local private facility, a bank, a department store, or an exhibition place, providing various administrative processes, product information, or guidance for users. The KIOSK is an overall unmanned information guidance system to provide users with useful information in the form of voice messages, motion pictures, and the like by means of high-tech multimedia devices such as touch screens, sound, graphic, or communication cards. A recent model of the KIOSK is associated with an advanced function capable of downloading sound sources, motion pictures, or game files.

To download photographs, sound sources, motion pictures, or game files in a short time, it is necessary to have a high communication speed (or rate) between the KIOSK and the multimedia card. The current technique has a limit, however, in permitting data communication between a multimedia card and a host with a maximum data rate of 50 Mbps through eight data pins.

### SUMMARY OF THE INVENTION

Exemplary embodiments of present invention are directed to provide a memory card with improved communication speed.

Exemplary embodiments of present invention are also directed to provide a memory card system including a memory card capable of communicating with a host operating in a fast mode.

Exemplary embodiments of present invention are further directed to provide a memory card and operation method capable of communicating with a host in a legacy/fast mode.

An exemplary embodiment of the present invention consists of a memory card including: first group pins; second group pins arranged apart from the first group pins; and a memory controller communicating externally through the first group pins in a legacy mode and communicating externally through the first and second groups of pins in a fast mode.

In an exemplary embodiment, the first group of pins includes a pin for a power voltage, a pin for a command, a pin for a clock, and a pin for data transmission.

In an exemplary embodiment, the second group of pins includes data pins for data transmission and at least one data pin for transferring a transmission rate information signal externally.

In an exemplary embodiment, the transmission rate information signal represents one of double and quad data rate modes.

In an exemplary embodiment, the fast mode is twice the legacy mode in data transmission rate.

In an exemplary embodiment, the first group pins are the same in number as the second group pins.

In an exemplary embodiment, the first group are symmetrical to the second group pins.

In an exemplary embodiment, the first group pins are different in number from the second group pins.

Another exemplary embodiment of the present invention is a memory card system including: a host; and a memory card operable in data communication with the host in a legacy mode or fast mode. The memory card includes: first group pins; second group pins; and a controller communicating with the host in the fast mode by way of the first and second group pins if the host is operable with data communication in the fast mode.

In an exemplary embodiment, the host sends the memory card transmission rate information.

In an exemplary embodiment, the controller of the memory card comprises a register storing the transmission rate information provided from the host.

In an exemplary embodiment, the controller of the memory card operates in one of the fast and legacy modes in response to the transmission rate information provided from the host.

In still another exemplary embodiment of the present invention, a method of operating a memory card connected to a host, is comprised of: transferring a strobe signal that represents a transmission rate when the memory card is connected to the host; and communicating with the host by way of first group pins and second group pins arranged at a distance from the first group pins if transmission rate information from the host indicates a fast mode.

In an exemplary embodiment, the method is further comprised of storing the received transmission rate information.

In an exemplary embodiment, the method is further comprised of communicating through the first group pins in a legacy mode if there is no reception of the transmission rate information from the host.

Exemplary embodiments of the present invention also provide a method of operating a memory card system including a host and a memory card connected to the host, being comprised of: detecting a connection of the memory card to the host; transferring a strobe signal, which represents a transmission rate, from the memory card to the host; sending transmission rate information to the memory cad from the host; setting the memory card to communicate with the host by way of first group pins and second group pins, arranged at a distance from the first group pins, if transmission rate information from the host indicates a fast mode.

In an exemplary embodiment, the fast mode includes dual and quad data rate modes.

In an exemplary embodiment, the method is further comprised of storing the transmission rate information received by the memory card.

A further understanding of the nature and advantages of the exemplary embodiments of the present invention described herein may be realized by reference to the remaining portions of the specification and the attached drawings.

### BRIEF DESCRIPTION OF THE FIGURES

Exemplary embodiments of the present invention will be understood in more detail from the following descriptions taken in conjunction with the accompanying figures, wherein like reference numerals refer to like parts throughout the various figures unless otherwise specified. In the figures:

FIG. 1 is a diagram illustrating a memory card according to an exemplary embodiment of the present invention, which is available for communication with a legacy host or fast host;

FIG. 2 is a diagram showing an exemplary pin allocation of the memory card shown in FIG. 1;

FIG. 3 is a block diagram illustrating an internal circuit structure of the memory card shown in FIG. 1;

FIG. 4 is a diagram showing conditions of transmission modes selected by first and second strobe signals;

FIG. 5 is a flow chart showing an operational procedure of a host connected with a fast memory card according to an exemplary embodiment of the present invention; and

FIG. 6 is a flow chart showing an operational procedure of a fast memory card according to an exemplary embodiment of the present invention.

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the exemplary embodiments set forth herein. Rather, these exemplary embodiments are provided so that this disclosure will the thorough and complete, and will fully convey the scope of the present invention to those skilled in the art. Like reference numerals refer to like elements throughout the accompanying figures.

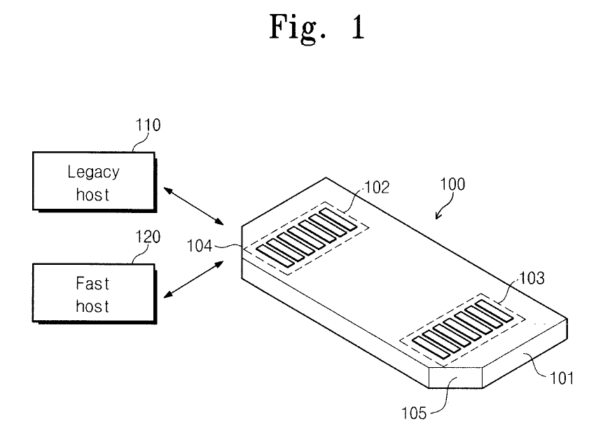

FIG. 1 illustrates a memory card according to an exemplary embodiment of the present invention, which is available for communication with a legacy host or a fast host.

The memory card 100 has a housing case 101 of the multimedia card (MMC) type. The housing case 101 is fabricated in a standard size of 24 mm length, 32 mm width, and 1.4 mm height. The housing case 101 contains a semiconductor memory, circuits for driving the semiconductor memory, and interfacing circuits for communicating with an external system. Exemplary embodiments of the present invention are applicable to an SD card, a Compact Flash card, a Smart Media card, a memory stick, and so on, as well as a multimedia card.

On an upper side of the housing case 101 are arranged a first group of pins (a first pin group) 102 and spaced apart therefrom on the upper side of the housing case 101 are arranged a second group of pins (a second pin group) 103. The pins of the first group 102 are legacy pins connectable with a legacy host 110, while the pins for the second group 103 are connected to a fast host 102. The first group pins 102 can be the same as or different from the second group pins 103 in regard to number. If the first group pins 102 are same in number as the second group pins 103, the first group pins 102 are arranged to be symmetrical with the second group pins 103.

A corner 104 of the housing case 101, at the end where the first group pins 102 are disposed, is shaped in a slant and another corner 105 thereof, at the end where the second group pins 103 are disposed, is also shaped in a slant. In this way, when the memory card 100 links to the legacy host 110, it prevents the second host pins 103 from being connected to the legacy host 110. Further, when the memory card 110 links to the fast host 120, positions of the first and second group pins 102 and 103 are exchanged to prevent the first group pins 102 from being connected to the fast host 120.

The legacy host 110 is referred to as a host coupled to a legacy card that is a conventional card, which can be connected to the first group pins 102 of the memory card 100 according to an exemplary embodiment of the present invention.

The fast host 120, such as KIOSK, is also associated with a connector (not shown) linkable with the second group pins 103, as well as the first group pins 102, and being able to communicate with the memory card 100 at a high frequency.

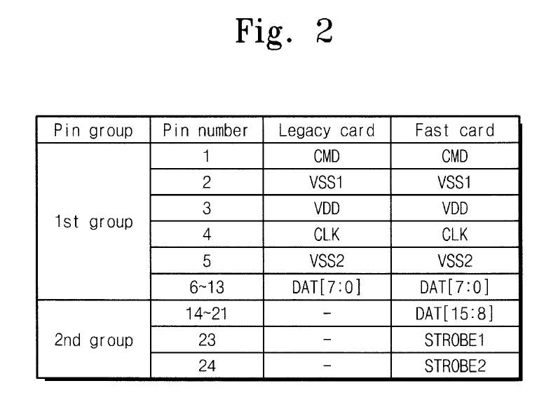

FIG. 2 is a diagram showing an exemplary pin allocation of the memory card 100 shown in FIG. 1. Referring to FIG. 2, the first group pins 102 include 13 pins and the second group pins 103 include 11 pins. The first group pins 102 are provided for a command CMD, ground voltages VSS1 and VSS2, a power source voltage VDD, a clock signal CLK, and data signals DAT[7:0]. The second group pins 103 are provided for data signals DAT[15:8] and first and second strobe signals STROBE1 and STROBE2. The number of the first or second group pins 102 or 103 are variable, for example, 7, 8, 11, or 13.

As is well known, a general legacy card just includes the first group pins 102 and communicates with the legacy host 110 shown in FIG. 1. Although the memory card 100 is operable in a fast mode, if a host is a legacy host just assisting a legacy mode, the memory card communicates with the legacy host 110 of FIG. 1 through the first group pins 102. Eight pins among the first group pin 102 are allocated for the data signals DAT[7:0].

The fast memory card 100 including the second group pins 103 in addition to the first group pins 102 communicates through the first and second group pins 102 and 103 with the fast host 110 shown in FIG. 1. Eight pins of the respective first and second group pins 102 and 103 are allocated to the data signals DAT[15:0]. Therefore, a data rate of communication between the fast host 120 and the memory card 100 is twice that of between the legacy host 110 and the memory card 110.

The 23'rd and 24'th pins in the second group pins 103 are provided for the first and second strobe signals STROBE1 and STROBE2. The first and second strobe signals STROBE1 and STROBE2 are provided for informing whether the fast transmission mode is operable in a double data rate (DDR) or a quad data rate (QDR). As well known, the DDR is a data transmission mode that transmits and receives (hereinafter, ‘transceives’) data signals in both rising and falling edges of the clock signal. On the other hand, the QDR mode is able to transceive data signals four times in one clock cycle. While the memory card 100 including the second group pins 103, in addition to the first group pins 102 for communicating with the legacy host 110, is basically operable in a double data rate over the legacy communication mode, the DDR or QDR mode employed therein enables the memory card 100 of this exemplary embodiment of the present invention to be operable in a faster data rate of four times or eight times. The first and second strobe signals STROBE1 and STROBE2 will be described in detail hereinbelow.

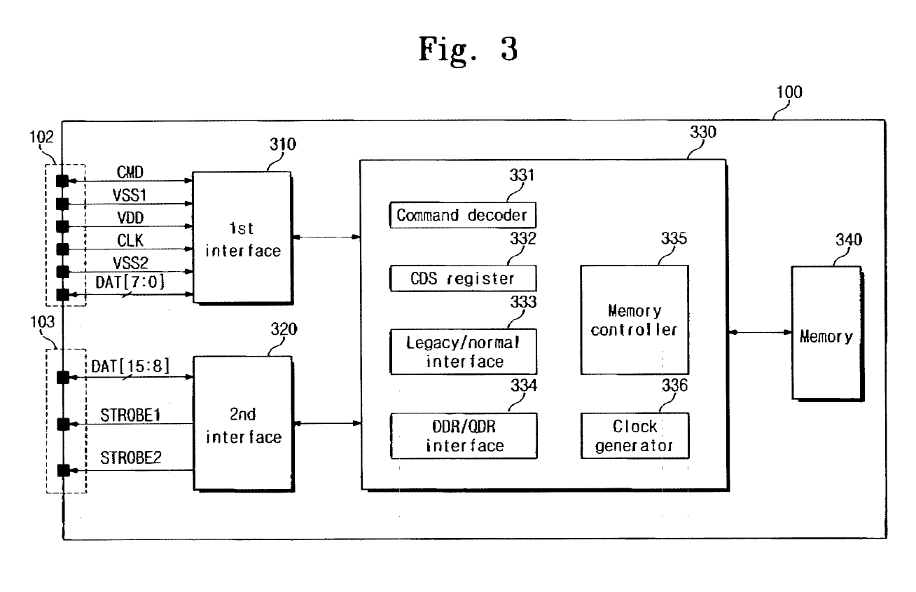

FIG. 3 is a block diagram illustrating an internal circuit structure of the memory card 100 shown in FIG. 1.

Referring to FIG. 3, the memory card 100 is comprised of a first interface 310, a second interface 320, a controller 330, and a memory 340. The first interface 310 is connected with the first group pins 102, transfers the command signal CMD, the power source and ground voltages VDD, VSS1, and VSS2, and the clock signal CLK to the controller 330 from an external host linking to the first group pins 102, and transmits the data signals DAT[7:0] between the host and the controller 330.

The second interface 320 is connected with the second group pins 103, transceives the data signals DAT[15:8] with the external host through the second group pins 103, and transmits the first an second strobe signals STROBE1 and STROBE2 to the external host. The memory 340 may be a flash memory or electrically erasable and programmable read-only memory (EEPROM).

The controller 330 is connected to the first and second interfaces 310 and 320 and the memory 340, and includes a command decode 330, a card specific data (CDS) register 332, a legacy/normal interface circuit 333, a DDR/QDR interface circuit 334, a memory controller 335, and a lock generator 336.

The command decoder 331 operates a decode the command signal CMD input from the host through the first interface 310, and conducts a control operation corresponding to the first interface 310. The CDS register 332 stores card operating parameters, such as the maximum data access time. More specifically, the CDS register 332 of the memory card 100, according to the exemplary embodiment of the present invention, stores information of the data transfer speed that corresponds to a current data transfer speed among legacy, normal, DDR, and QDR modes.

The memory controller 335 conducts an access operation to the memory 340. Namely, the memory controller 335, according to a command decoded by the command decoder 331, writes data into the memory 340 and reads or erases data from the memory 340. The clock generator 336 divides the frequency of the clock signal CLK provided from the host and generates clock signals required for the memory card 100.

The legacy/normal interface circuit 333 enables the controller 330 to communicate with the host by way of the first or second interfaces 310 or 320 when a data transmission mode is in the normal mode, but not in the legacy or DDR/QDR mode. The normal mode means a data transmission mode in which the memory card 100 according to the exemplary embodiment of the present invention, communicates with the fast host 120 through the first and second group pins 102 and 103, but not the DDR or QDR mode. Namely, the memory card 100 is operable in one of the legacy and fast modes. The fast mode includes a fast normal mode, the DDR mode, and the QDR mode.

The DDR/QDR interface circuit 334 enables the controller 330 to communicate with the host through the first and second interfaces 310 and 320 when a data transmission mode between the host and the memory card 100 is the DDR or QDR mode among the fast modes.

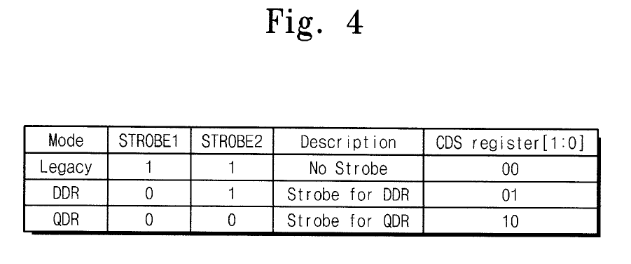

FIG. 4 is a diagram showing conditions of transmission modes selected by the first and second strobe signals STROBE1 and STROBE2. If the memory card 100 links to the host, the power voltages VSS1, VSS2, and VDD are supplied into the memory card 100. After initializing the memory card 100, the DDR/QDR interface circuit 334 of the memory card 100 assisting the DDR/QDR mode outputs the first and second strobe signals STROBE1 and STROBE2.

The host communicates with the memory card 100 in the DDR/QDR mode in compliance with states of the first an second strobe signals STROBE1 and STROBE2 transferred from the memory card 100. The host connects pull-up resistors (not shown) to the signal lines to which the first and second strobe signals STROBE1 an STROBE2 are applied, detects whether there is an input of the first and second strobe signals STROBE1 and STROBE2 and detects the voltage levels of the first and second strobe signals STROBE1 and STROBE2.

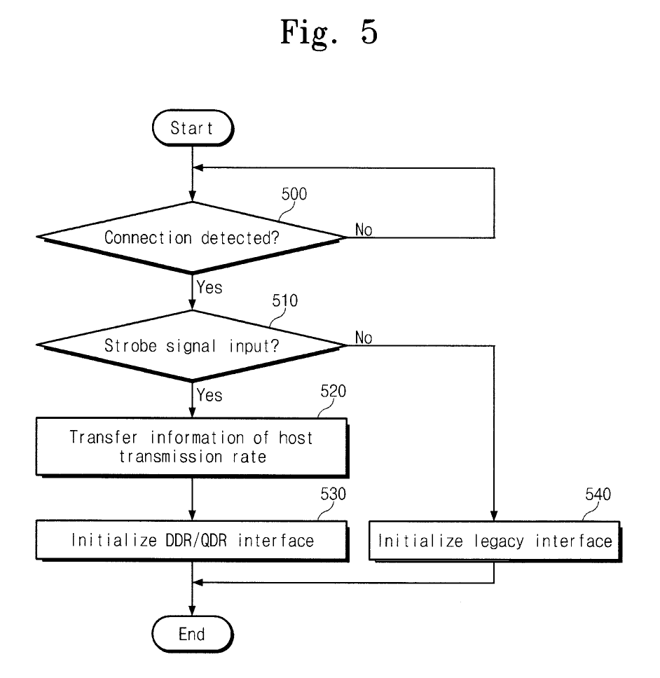

FIG. 5 is a flow chart for an operation procedure of the host connected with the fast memory card according to the exemplary embodiment of the present invention. The flow chart of FIG. 5 shows an operational procedure of the fast host 120 shown in FIG. 1 assisting the DDR/QDR mode.

The host 120, if a connection to the memory card 100 is detected (step 500), supplies power to the memory card 100 and initializes the memory card 100. The host 120 detects voltage levels on the strobe signal lines (not shown) and identifies a current communication mode (or data transmission mode) of the memory card 100 (step 510). For instance, as shown in the table of FIG. 4, if the strobe signal lines are all at high levels after initializing the memory card 100, the host 120 determines that the memory card 100 does not assist the DDR/QDR mode. More specifically, the host 120 assists the fast mode, but not the DDR or QDR mode. After that, the fast host 120 communicates with the memory card 100 in the fast normal mode.

The host 120, if the first strobe signal STROBE1 is at the low level an the second strobe signal STROBE2 is at the high level, determines a current communication mode as the DDR mode. But, if the first strobe signal STROBE1 is a the high level and the second strobe signal STROBE2 is at the low level, a current communication mode is determined as the QDR mode. The host 120 sends the memory card 100 information of the transmission rate (that is, the speed of data transmission) corresponding to the detected communication mode (step 520). If the host 120 assists only one of the DDR and QDR modes, the host 120 sends the memory card 100 information of the permissible transmission rate. If the host 120 assists neither of the DDR and QDR modes, the host 120 sends the memory card 100 information of the transmission rate corresponding to the normal mode, although it really is the fast mode.

Thereafter, the host 120 conducts fast interface initialization for carrying out the fast mode by way of the first and second group pins 102 and 103 of the memory card 100 (step 530). If no strobe signals are input, the host 120 conducts interface initialization for carrying out the legacy mode (step 540).

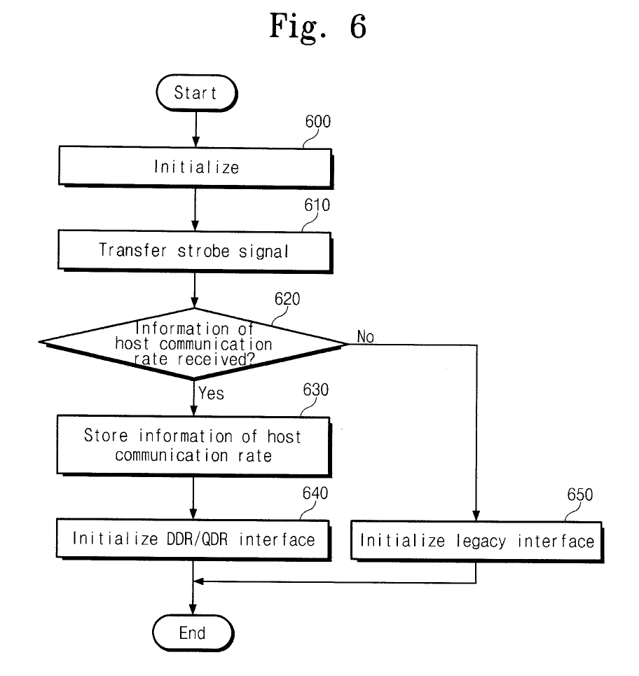

FIG. 6 is a flow chart showing an operational procedure of the fast memory card according to an exemplary embodiment of the present invention.

Referring to FIG. 6, the memory card 100 links with the host, controls the clock generator 336 to generate the clock CLK when there is power supplied from the host, and initializes the internal circuits of the controller 330 (step 600).

The DDR/QDR interface circuit 334 transfers the first and second strobe signals STROBE1 and STROBE2 to the host in accordance with an operation speed assisted by the controller 330 (step 610).

If the host linking with the memory card 100 is the legacy host 110, there is no reception of transmission rate information from the host 100. After transferring the first and second strobe signals STROBE1 and STROBE2, if there is no reception of the transmission rate information from the host in a predetermined time, the memory card 100 detects a connection to the legacy host 110 and conducts initialization for the legacy interface 333 (step 650). Then, the memory card 100 communicates with the legacy host 110 by way of the first interface 310 and the first group pins 102.

The transmission rate information received from the host is stored in the CDS register 332 (step 630). The controller 330 conducts initialization for the fast interface in accordance with the transmission rate information stored in the CDS register 332 (step 640). The DDR/QDR interface circuit 334 sets a communication mode from the DDR or QDR mode in compliance with the transmission rate information stored in the CDS register 332. After that, the memory card 100 communicates with the fast host 120 by way of the first and second interfaces 310 and 330, and the first and second group pins 102 and 103.

As described above, a data communication speed (that is, data rate) between the fast host and the memory card is enhanced. Moreover, the memory card provided by the exemplary embodiment of the present invention is able to be available for communication with the legacy host for fast data communication as well.

The above-disclosed subject matter is to be considered illustrative, and not restrictive, and the appended claims are intended to cover all such modifications, enhancements, and other exemplary embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory card comprising:
first group pins;
second group pins arranged apart from the first group pins; and
a memory controller communicating externally through the first group pins in a legacy mode and communicating externally through the first and second group pins in a fast mode.

2. The memory card as set forth in claim 1, wherein the first group pins comprise a pin for a power voltage, a pin for a command, a pin for a clock, and a pin for data transmission.

3. The memory card as set for the in claim 1, wherein the second group pins comprise data pins for data transmission and at least a data pin for transferring a transmission rate information signal externally.

4. The memory card as set forth in claim 3, wherein the transmission rate information signal represents one of double and quad data rate modes.

5. The memory card as set forth in claim 1, wherein the first group pins are arranged on an edge location of a first face of the memory card and the second group pins are arranged on another edge location of the first face of the memory card spaced apart from the first group pins.

6. The memory card as set for the in claim 1, wherein the number of the first group pins is the same as the number of the second group pins.

7. The memory card as set forth in claim 6, wherein the first group pins are symmetrical with respect to the second group pins.

8. The memory card as set forth in claim 1, wherein the number of the first group pins is different from the number of the second group pins.

9. A memory card system comprising:
a host; and
a memory card operable for data communication with the host in a legacy or fast mode,
wherein the memory card comprises:
first group pins;
second group pins; and
a controller communicating with the host in the fast mode by way of the first and second group pins when the host is operable for data communication in the fast mode.

10. The memory card system as set forth in claim 9, wherein the host sends transmission rate information to the memory card.

11. The memory card system as set forth in claim 10, wherein the controller of the memory card comprises a register storing the transmission rate information sent from the host.

12. The memory card system as set forth in claim 10, wherein the controller of the memory card operates in one of the fast and legacy modes in response to the transmission rate information sent from the host.

13. The memory card system as set forth in claim 12, wherein the controller of the memory card operates in the legacy mode when there is no reception of the transmission rate information sent from the host.

14. The memory card system as set forth in claim 9, wherein the first group pins comprise a pin for a power voltage, a pin for a command, a pin for a clock, and a pin for data transmission.

15. The memory card system as set forth in claim 14, wherein the second group pins comprise data pins for data transmission and at least a data pin for transferring a transmission mode signal to the host.

16. The memory card system as set forth in claim 15, wherein the number of pins for data transmission in each of the first and second group pins is eight.

17. The memory card system as set forth in claim 14, wherein the transmission mode signal is a double or quad data rate mode.

18. The memory card system as set forth in claim 9, wherein a data transmission rate in the fast mode is twice as fast as in the legacy mode.

19. A method of operating a memory car connected to a host, the method comprising:
transferring a strobe signal that represents a transmission rate when the memory card is connected to the host; and
communicating with the host by way of first group pins and second group pins spaced apart from the first group pins when transmission rate information transferred from the host indicates a fast mode.

20. The method as set forth in claim 19, which further comprises: storing the received transmission rate information.

21. The method as set forth in claim 19, which further comprises: communicating through the first group pins in a legacy mode when there is no reception of the transmission rate information from the host.

22. A method of operating a memory card system including a host and a memory card connected to the host, the method comprising:
detecting a connection of the memory card to the host;
transferring a strobe signal, which represents a transmission rate, from the memory card to the host;
sending transmission rate information to the memory card from the host;
setting the memory card to communicate with the host by way of first group pins and second group pins spaced apart from the first group pins when transmission rate information from the host indicates a fast mode.

23. The method as set forth in claim 22, wherein the fast mode includes dual and quad data rate modes.

24. The method as set forth in claim 23, which further comprises: storing the transmission rate information received by the memory card.
